(19) United States
(12) Patent Application Publication
(10) Pub. No.: US 2020/0410587 A1
(43) Pub. Date: Dec. 31, 2020

(54) Prioritized Distribution of Funds in Reverse Mortgages

(71) Applicant: QuantumReverse Inc., Raleigh, NC (US)

(72) Inventor: Thomas M. Martignoni, Raleigh, NC (US)

(73) Assignee: QuantumReverse Inc., Raleigh, NC (US)

(21) Appl. No.: 16/993,460

(22) Filed: Aug. 14, 2020

Related U.S. Application Data
(62) Division of application No. 16/296,347, filed on Mar. 8, 2019.
(60) Provisional application No. 62/641,499, filed on Mar. 12, 2018.

(51) Int. Cl. G06Q 40/02; G06Q 40/00; H04W 4/14

(52) U.S. Cl. CPC G06Q 40/025; H04W 4/14; G06Q 40/12

(57) ABSTRACT

Disbursements in an electronic reverse mortgage application may be prioritized. When a borrower applies for a reverse mortgage, the borrower submits the electronic reverse mortgage application. At closing the borrower will receive one or more disbursements (such as cash at closing, a monthly disbursement, and/or a line of credit). The borrower or other user, however, may prioritize the multiple disbursements according to a disbursement priority. The borrower or other user establishes or assigns different disbursement priorities to the cash at closing, the monthly disbursement, and/or the line of credit. Available proceeds of the reverse mortgage are calculated, and then the various disbursements are calculated according to the disbursement priorities.

### CROSS-REFERENCE TO RELATED APPLICATIONS

This patent application is a divisional of U.S. application Ser. No. 16/296,347 filed Mar. 8, 2019, which claims domestic benefit of U.S. Provisional Application No. 62/641,499 filed Mar. 12, 2018, with both patent applications incorporated herein by reference in their entireties.

### BACKGROUND

Reverse mortgages provide immediate money to borrowers. Usually the funds available to the borrower can be distributed or disbursed in the following ways:

Cash at closing to the borrower,

Monthly disbursements (term payments), and

Line of credit.

Subject to certain limitations the borrower can freely allocate the funds to these distributions.

The origination of a reverse mortgage from first contact to closing is a lengthy process. The total amount of funds available to the borrower for disbursement is likely to change during the process, as new information is discovered and included into the calculation of the funds available to the borrower. The process is further complicated by the fact that additional restrictions to the disbursement of the funds may be applied. Hence, conventional schemes are challenged to adjust the borrower's desired allocation of funds during the process. The conventional schemes require a loan officer to track and make changes to the allocation with each change in the available funds.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified illustration of an operating environment, according to exemplary embodiments;

FIG. 2 illustrates software componentry, according to exemplary embodiments;

FIG. 3 illustrates a proceeds calculator, according to exemplary embodiments;

FIGS. 4-5 illustrate a disbursement calculator, according to exemplary embodiments;

FIG. 6 illustrates an architectural scheme, according to exemplary embodiments; and

FIGS. 7-8 illustrate a graphical user interface, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

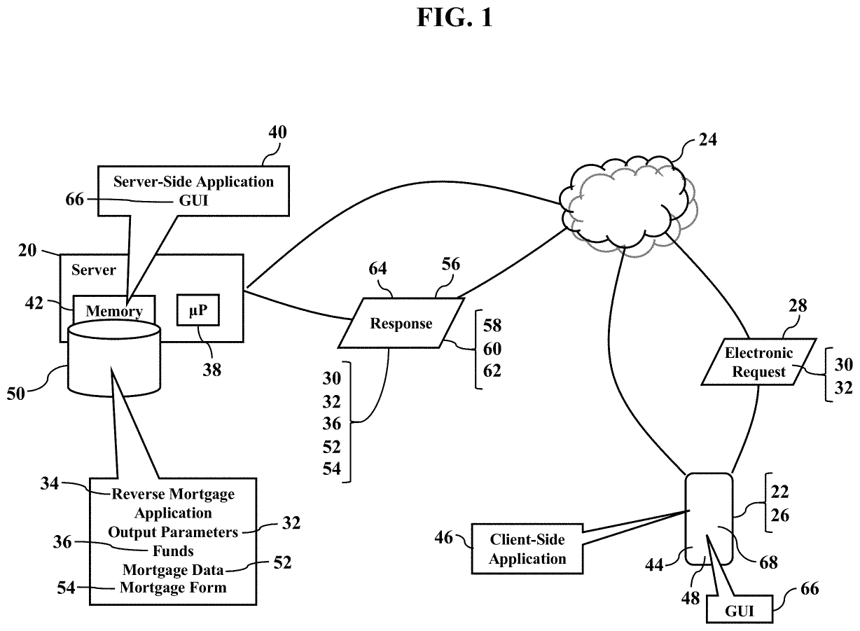

FIG. 1 is a simplified illustration of an operating environment, according to exemplary embodiments. A server 20 communicates with a client device 22 via a communications network 24. FIG. 1 illustrates the client device 22 as a mobile smartphone 26, which most readers are thought familiar. The client device 22, however, may be a server, mobile tablet, computer, or any other processor-controlled device, as later paragraphs will explain. Regardless, the client device 22 sends an electronic request 28 via the communications network 24 to a network address (e.g., Internet protocol address) associated with the server 20. The electronic request 28 specifies one or more inputs 30 and requests output parameters 32 associated with an electronic reverse mortgage application 34.

The user may particularly request funding scenarios and information associated with the electronic reverse mortgage application 34. As the reader may understand, most applicants (or their authorized loan officer or back-office representative) submit the electronic reverse mortgage application 34 to obtain cash, monthly payments, or a line of credit. The disbursements and allocations of funds 36, in other words, is important to most borrowers. Because the electronic reverse mortgage application 34 is a lengthy process, though, the total amount of funds 36 available to the borrower dynamically changes as the origination process proceeds and new information is discovered and analyzed. Simply put, whenever any one of the inputs 30 changes, the server 20 may determine that the total amount of funds 36 available to the borrower dynamically changes. While there may be many, perhaps even hundreds, of the inputs 30, this disclosure mainly discusses the inputs 30 thought familiar to most readers (such as property value, lending limits, borrower name and/or age, property location, interest rate, selected product, mandatory obligations, and financial assessment). Whenever the mobile smartphone 26 submits a change in value to any of the inputs 30, the server 20 may calculate a corresponding change in the funds 36 available to the borrower.

The server 20 may thus calculate the funds 36. The server 20 receives the electronic request 28 and inspects the electronic request 28 for the inputs 30. The server 20 may then calculate the output parameters 32 related to the electronic reverse mortgage application 34, with the output parameters 32 based on the values of the inputs 30. The user may thus dynamically change the inputs 30 and in real time or near real time obtain the output parameters 32 generated in response to the inputs 30. The user (such as a loan officer or a borrower) may thus change the values of the inputs 30 and obtain the server's calculations regarding the corresponding funds 36 available to the borrower.

The server 20 generates the output parameters 32 associated with the electronic reverse mortgage application 34. The server 20 has a processor 38 that executes a server-side application 40 stored in a solid-state memory device 42. The mobile smartphone 26 has a processor 44 that executes a client-side application 46 stored in a solid-state memory device 48. The server-side application 40 and the client-side application 46 may thus cooperate (perhaps in a client-server relationship) to request and specify the inputs 30 and to generate the output parameters 32. For example, the server 20 inspects the electronic request 28 for the values of the inputs 30 specified by the user of the mobile smartphone 26. The server 20 may then apply the inputs 30 to the server-side application 40 and thus generate the output parameters 32 (such as the funds 36 available to the borrower). As the server 20 executes the server-side application 40, the server 20 may also store the inputs 30 and their corresponding output parameters 32 in an electronic database 50. Indeed, the electronic database 50 may store any electronic mortgage data 52 associated with the electronic reverse mortgage application 34. The electronic database 50 may thus be queried for any query parameter (such as any of the values associated with the inputs 30) to identify the corresponding output parameters 32 and other electronic mortgage data 52 stored within or referenced by the electronic database 50. The server-side application 34 may thus instruct or cause the processor 38 to retrieve the output parameters 32 and the electronic mortgage data 52 and use the output parameters 32 and the electronic mortgage data 52 to assemble or to arrange one or more mortgage forms 54. Regardless, after the server 20 calculates the output parameters 32, the server 20 may generate a graphical user interface 66 for display by a display device (not shown for simplicity). The server-side application 34 instructs or causes the processor 38 to generate the graphical user interface 66 to display the output parameters 32. The server-side application 34, additionally or alternatively, may instruct or cause the processor 38 to send a response 56 to the network address (e.g., Internet protocol address) associated with the mobile smartphone 26.

The mobile smartphone 26 receives the response 56. The response 56 may be sent as one or more packetized messages 58, web pages 60, or short message service (SMS) messages 62. The response 56 may additionally or alternatively be posted to a social network. Regardless, the response 56 may contain or specify the inputs 30 used to calculate the output parameters 32, any electronic mortgage data 52, and/or the mortgage forms 54. The response 56, in particular, may contain the funds 36 available to the borrower that were calculated by the server-side application 40. The response 56 may also contain or reference a hyperlink 64 that permits the mobile smartphone 26 to download documents or data referenced by the funds 36 available to the borrower. When the mobile smartphone 26 receives the response 56, the client-side application 34 instructs or causes its processor 44 to present the response 56 to the user. The mobile smartphone 26, for example, may generate the graphical user interface (or GUI) 66 for display by its display device 68. The graphical user interface 66 incorporates the output parameters 32, the funds 36, the electronic mortgage data 50, the mortgage forms 54, and/or the hyperlink 64. The graphical user interface 66, in particular, may contain the funds 36 available to the borrower that were calculated by the server-side application 40. The mobile smartphone thus visually and/or audibly presents the graphical user interface 66 to the user.

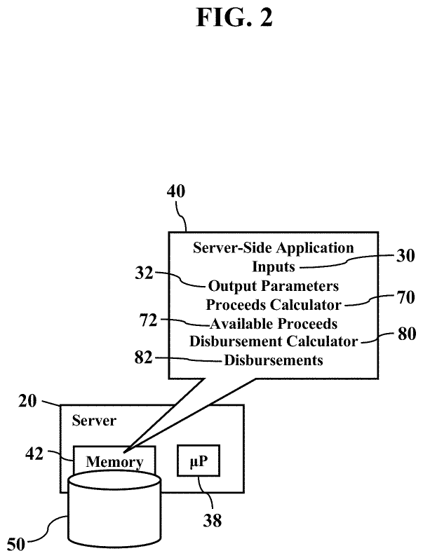

FIG. 2 further illustrates the server 20, according to exemplary embodiments. The server 20 locally stores the server-side application 40 in the solid-state memory device 42. The server-side software application 40 may have one or more software modules or components that are executed by the processor 38. A proceeds calculator 70, for example, accepts at least some of the inputs 30 and calculates an Available Proceeds 72 as one of the output parameters 32, which later paragraphs will explain. A disbursement calculator 80 accepts at least some of the inputs 30 and the Available Proceeds 72 to calculate various disbursements 82 as some of the output parameters 32, which later paragraphs will explain.

The funds 36 available to the borrower may be dynamically changed and prioritized. The graphical user interface 66 provides an easy and intuitive way for loan officers or borrowers to allocate funds and to set priorities. Before further explaining prioritized disbursements, the following definitions are used in this disclosure:
Available Proceeds—The total funds available to the borrower for disbursement in one or multiple ways;
Cash At Closing—The effective amount of cash disbursed to the borrower at the closing or funding of the loan;
Cash At Closing Request—The requested amount of Cash At Closing by the borrower;
Monthly Disbursement—A monthly term or tenure disbursement to the borrower;
Monthly Disbursement Request—The requested Monthly Disbursement by the borrower;
Line of Credit—A line of credit available to the borrower;
Line of Credit Request—The requested Line of Credit by the borrower; and
Disbursement Priority—The priority order of the disbursements (like 1. Monthly Disbursement, 2. Cash at Closing, 3. Line of Credit).

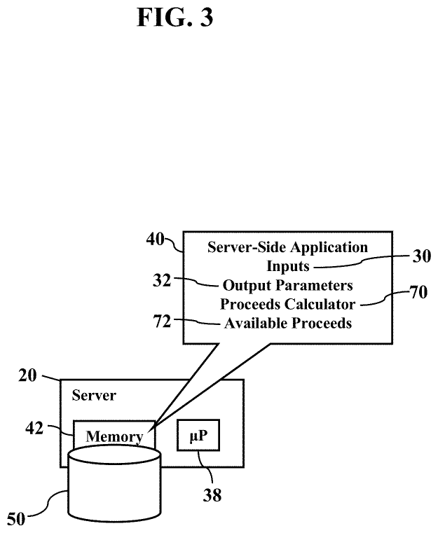

FIG. 3 further illustrates the proceeds calculator 70, according to exemplary embodiments. The proceeds calculator 70 may be a module or component of the server-side software application 40. The proceeds calculator 70 may additionally or alternatively be a module or component of the client-side application 46. The server-side software application 40 and the client-side application 46 may thus cooperate, perhaps in a client-server arrangement, to provide, to generate, or to function as the proceeds calculator 70. The proceeds calculator 70 may utilize any programming language or technique, such as JAVA® script. Regardless, the proceeds calculator 70 performs a calculation for the Available Proceeds 72 as one of the output parameters 32, based on the inputs 30 (such as parameters of property value, lending limits, borrower name or age, location, interest rates, selected product, mandatory obligations, financial assessment and others). The Available Proceeds 72 is an amount of a currency. The Available Proceeds 72 are calculated and subject to change during the course of the origination process and/or in response to changes caused by modifications or developments in the inputs 30. In other words, the final amount of Available Proceeds 72 at the loan closing of the electronic reverse mortgage application 34 is unlikely to be exactly the amount the borrower may have been disclosed in the initial steps of the origination process.

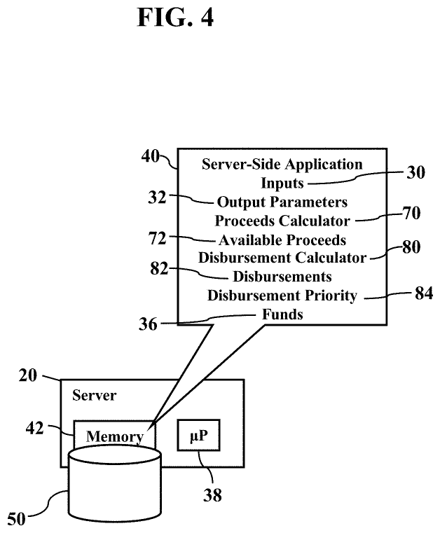

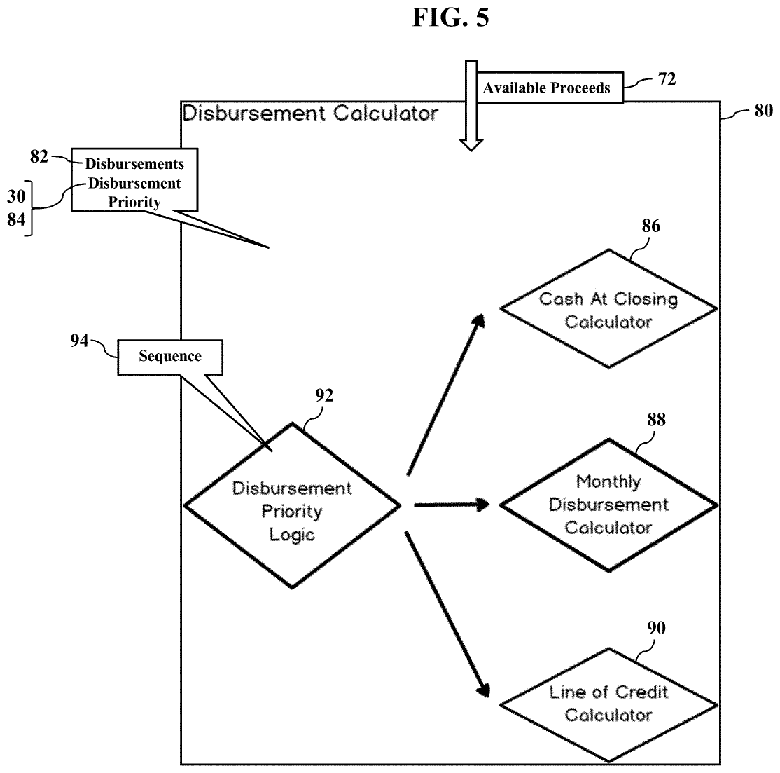

FIGS. 4-5 further illustrate the disbursement calculator 80, according to exemplary embodiments. The disbursement calculator 80 is another module or component of the server-side software application 40 that calculates the disbursements 82 due to the borrower. The disbursement calculator 80 accepts the limits for the Available Proceeds 72 from the Proceeds Calculator 70. The user of the server-side application 40 and/or the client-side application 46 (illustrated in FIG. 1) selects or defines the inputs 30 that are processed to determine the disbursements 82 due to the borrower. For example, the user (such as a loan officer, the borrower or a back-office worker for a lender or broker) enters the Cash At Closing Request, the Monthly Disbursement Request, the Line of Credit Request and one or more Disbursement Priorities 84. So, whenever any of the inputs 30 change, the Available Proceeds 72 change, and/or another trigger changes (such as a change in the Disbursement Priority 84), the Disbursement Calculator 80 may recalculate the disbursements 82 (such as the funds 36 available to the borrower).

As FIG. 5 illustrates, the disbursement calculator 80 may comprise several sub-units. Each one of the sub-units may evaluate a particular one of the disbursements 82 based on the set of the inputs 30 (such as the requested amount for such disbursement 82, whether it is a one-time disbursement or a repetition of payments, applying net present value and similar calculation methods and logical rules to the particular disbursement 82). FIG. 5 particularly illustrates an implementation of the Disbursement Calculator 80 having Cash At Closing Calculator 86, a Monthly Disbursement Calculator 88, a Line of Credit Calculator 90, and a Disbursement Priority Logic 92. The disbursement calculator 80 and/or the Disbursement Priority Logic 92 receives the Disbursement Priority 84 as one of the inputs 30 (perhaps via the graphical user interface 66 as earlier explained, or as a data read operation stored in the solid-state memory device 42 (illustrated in FIG. 4). The disbursement calculator 80 also receives the Available Proceeds 72. The disbursement calculator 80 calculates the different disbursements 82, perhaps one after the other in a sequence 94 according to the disbursement priority 84. The disbursement calculator 80 calculates the respective amounts of the disbursements 82 and the amount left for other disbursements. This sequence 94 is established by the logic of the Disbursement Priority Logic 92 based on the Disbursement Priority 84 specified by the user and other restrictive parameters.

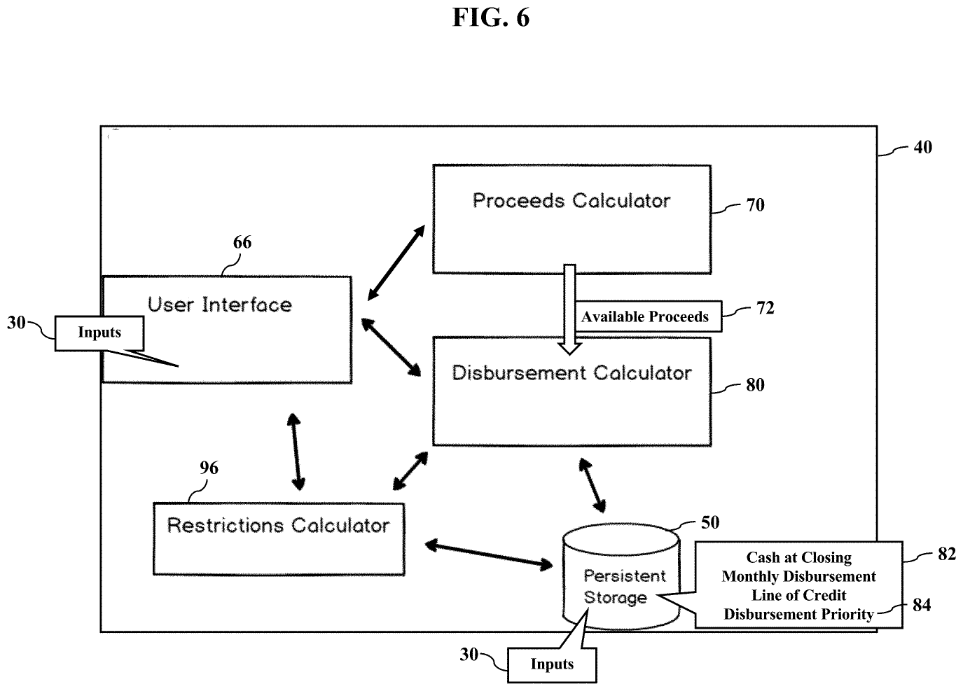

FIG. 6 illustrates an architectural scheme, according to exemplary embodiments. The proceeds calculator 70 and the disbursement calculator 80 may be software modules or components of the server-side software application 40. The proceeds calculator 70 and the disbursement calculator 80 may additionally or alternatively be software modules or components of the client-side application 46. The inputs 30 are received (perhaps via the graphical user interface 66, as earlier explained). Whenever any value of any input 30 is changed, the Disbursement Calculator 80 recalculates all or part of the values of the disbursements 82. The Disbursement Calculator 80, for example, may calculate or generate the disbursements 82 as a Cash At Closing, a Monthly Disbursement, and a Line of Credit according to the borrower's requested Disbursement Priorities 84. The Disbursement Calculator 80 may also store the values of the inputs 30 and their corresponding values of the disbursements 82 in Persistent Storage (such as the electronic database 50). The Persistent Storage is used to restore the values 30, 82, and 84 after a power-out, a time-out or otherwise a situation where the graphical user interface 66 gets disconnected or the input values 30 need to be restored for the Disbursement Calculator 80 and/or the graphical user interface 66. The Persistent Storage, for example, may be a RAM, ROM, or SSD non-volatile memory device 42. The Disbursement Calculator 80 interacts with a Restrictions Calculator 96 to possibly restrict some values 30 and/or 82 based on additional logical rules when performing calculations. The graphical user interface 66 may also interact with the Restrictions Calculator 96, making the user aware of particular restrictions.

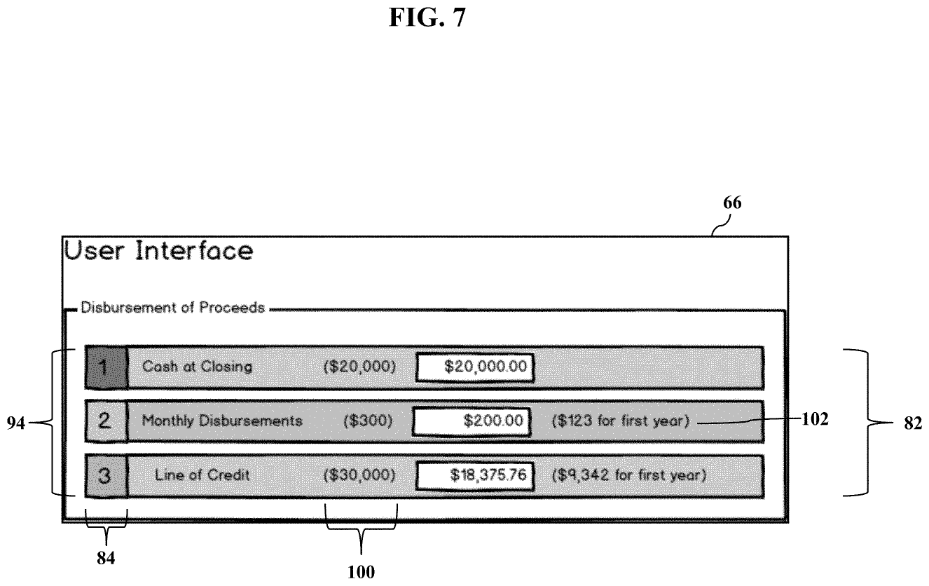

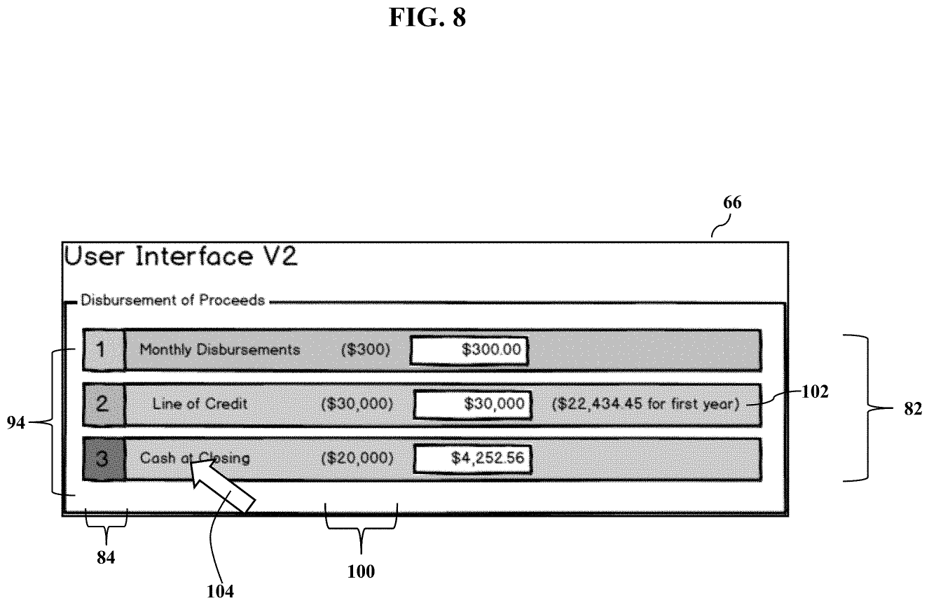

FIGS. 7-8 illustrate the graphical user interface 66, according to exemplary embodiments. The graphical user interface 66 is displayed by a display device (such as the touch screen display device 68 of the mobile smartphone 26, as illustrated in FIG. 1). The graphical user interface 66, however, may also be displayed by an LED, LCD, plasma, oleo, touch screen, or other monitor or display device that interfaces with the server 20 (illustrated in FIG. 1). Regardless, the graphical user interface 66 presents different options for the disbursements 82, according to the borrower's requested Disbursement Priorities 84 and perhaps defining the sequence 94 at which the different disbursements 82 are represented, selected, and/or prioritized. The Disbursement Priority 84 is defined by an intuitively understandable arrangement or labeling of the disbursement categories 82. In FIG. 7, for example, the borrower's first priority 84 is Cash at Closing (perhaps as indicated by the numerical Disbursement Priority 84 “1” and/or through the top position assigned to this prioritized disbursement). The position and sequence 94 of each such disbursement 82 may be specified by the user or the borrower (perhaps selected via the graphical user interface 66, as earlier explained). The Disbursement Priority 84, for example, may be specified by a numbering process or by graphically moving the positions of the disbursements 82 within the graphical user interface 66 (such as with a tactile mouse, finger, or other pointing device), thus altering the positions of the sequence 94 and triggering recalculations of the disbursements 82.

The graphical user interface 66 may present comparisons. That is, the graphical user interface 66 may display the borrower's requested disbursements 100 and the actual or calculated disbursements 82. For example, the user's/borrower's first Disbursement Priority 84 was Cash At Closing and requested to be $20,000. The graphical user interface 66 shows that the first Disbursement Priority 84 was satisfied, as the same amount is shown in the next field, which represents the calculated Cash at Closing of $20,000. The second Disbursement Priority 84 is the Monthly Disbursement, where the requested amount was $300. However, this requested amount could not be satisfied (for whatever reason, perhaps that was generated by the Restriction Calculator 96 illustrated in FIG. 6), as the calculated effective Monthly Disbursement as shown in the next field is only $200. The Monthly Disbursement is calculated from the allocated funds for monthly disbursements, possibly with a net present value calculation. Furthermore, there is an additional restriction 102 (perhaps generated by the Restriction Calculator 96 illustrated in FIG. 6) and shown as ($112 for first year). The third Disbursement Priority 84 is the Line of Credit. As this is perhaps the user's/borrower's least or smallest priority, subject to other limits, the Line of Credit will get the rest of the Available Proceeds 72 (illustrated in FIG. 6) that have not yet been allocated to other disbursement categories 82. In this example, subject to other restrictions, if the Funds Available increase, meaning additional funds become available, they will be added to the Monthly Disbursements, as these are in second priority and the request for Cash at Closing in first position is already satisfied. On the other hand, if the Funds Available should decrease, then they will first be taken from the last category, in this case the Line of Credit will be lowered.

The prioritizing of the disbursements 82 (such as the sequence 94) may be persistently stored by the server 20 and/or the mobile smartphone 26. The prioritizing of the disbursements 82 (such as the sequence 94) may be independent from the actual amount of the disbursements 82.

FIG. 8 illustrates different priority scenarios. Here the graphical user interface 66 indicates that the borrower's requested disbursements 100 are exactly the same amounts as in FIG. 7, however the Disbursement Priorities 84 are different. For example, the Monthly Disbursement has the first Disbursement Priority 84, requested to be $300, and the next, horizontally adjacent field indicates that the $300 request is satisfied. The second Disbursement Priority 84 is the Line of Credit, requested to be $30,000, and can be satisfied, however subject to the additional restriction 102 (perhaps generated by the Restriction Calculator 96 illustrated in FIG. 6) that only $22,434.45 is available for the first year. The third Disbursement Priority 84 is Cash at Closing, requested to be $20,000, but cannot be satisfied. That is, only $4,252.56 can be disbursed as Cash at Closing (perhaps because there are not enough Available Funds for a higher disbursement). FIGS. 7-8 thus illustrate that real-time changes to the inputs 30 may cause dynamic changes to the calculated disbursements 82.

Real-time changes to the Disbursement Priorities 84 may also cause dynamic changes to the calculated disbursements 82. FIGS. 7-8 thus illustrate that when the requested disbursements 100 are identical, but different Disbursement Priorities 84 are specified, the calculated disbursements 82 may change. By simply rearranging the sequence 94 of the Disbursement Priorities 84 of the disbursements 82 (such as by graphical movement using a cursor 104 in the graphical user interface 66 or numerical change in the sequence 94), a recalculation by the Disbursement Calculator 80 is triggered. Such recalculation may lead to different amounts for each disbursement 82 even though the requested disbursements 100 have not changed.

Exemplary embodiments may utilize any processor-controlled device. FIG. 1, for example, illustrates the server 20 and the mobile smartphone 26. However, the server-side software application 40 and the client-side application 46 may be stored and executed by any processor-controlled device. The processor-controlled device may be a desktop computer, mobile or tablet computer, tablet, digital watch, digital media player, digital television, or any other device having the processor and the solid-state memory device. The processor-controlled device has a network interface to the communications network 24, thus allowing two-way, bidirectional communication with clients, servers, and other network-accessible devices. The server-side application 40 and the client-side application 46 include instructions, code, and/or programs that cause the processor-controlled device to perform operations, such as receiving the inputs 30 and calculating the disbursements 82. The disbursements 82 may be stored or saved to the electronic database 50 in electronic association with their corresponding inputs 30. That is, the electronic database 50 may be represented as a table having tabular (e.g., columns and rows) entries that further map or associate any of the inputs 30 to the output parameters 32 and, in particular, to the disbursements 82 generated by the Disbursement Calculator 80. Any of the entries in the electronic database 80 may be identified and/or retrieved and sent as a packetized message via the communications network to any other device or network address (e.g., Internet protocol address). The processor-controlled device may thus accept or receive queries from clients, and each query specifies a query parameter. If the electronic database contains or references a satisfying or matching entry, any related entries may be identified and send as a query response to the client.

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations,” this could include the processor performing the operations directly and/or facilitating, directing, or cooperating with another device or component to perform the operations.

Exemplary embodiments may packetize. When the processor-controlled device communicates via the communications network, the processor-controlled device may collect, send, and retrieve information. The information may be formatted or generated as packets of data according to a packet protocol (such as the Internet Protocol). The packets of data contain bits or bytes of data describing the contents, or payload, of a message. A header of each packet of data may contain routing information identifying an origination address and/or a destination address.

Exemplary embodiments may be physically embodied on or in a computer-readable memory device or other storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for dynamic calculation of the prioritized disbursements 82, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method for prioritizing disbursements for an electronic reverse mortgage application, comprising:
displaying, by a device, via a graphical user interface, the disbursements of proceeds calculated by the electronic reverse mortgage application;
receiving, by the device, user inputs to the graphical user interface that represent graphical movements within the graphical user interface of the disbursements of the proceeds determined by the electronic reverse mortgage application;
determining, by the device, graphical positions of the disbursements of the proceeds displayed via the graphical user interface, the graphical positions based on the user inputs to the graphical user interface that represent the graphical movements;
assigning, by the device, pre-set priorities to the disbursements of the proceeds, the pre-set priorities assigned based on the graphical positions of the disbursements of the proceeds displayed via the graphical user interface;
in response to the user inputs to the graphical user interface that represent the graphical movements of the disbursements of the proceeds, triggering, by the device, a recalculation of the disbursements of the proceeds by the electronic reverse mortgage application;
identifying, by the device, software calculators for recalculating the disbursements of the proceeds; and
generating, by the device, prioritized disbursements as outputs to the electronic reverse mortgage application by sequentially executing the software calculators according to the pre-set priorities assigned based on the graphical positions.

2. The method of claim 1, further comprising calculating the disbursements of the proceeds.

3. The method of claim 1, further comprising receiving the user inputs via a communications network.

4. The method of claim 1, further comprising:
changing any of the disbursements of the proceeds; and
regenerating, by the server, the prioritized disbursements by sequentially re-executing the software calculators based on the changing of the available proceeds.

5. The method of claim 1, further comprising persistently storing the disbursements of the proceeds in a non-volatile memory.

6. The method of claim 1, further comprising persistently storing the pre-set priorities in a non-volatile memory.

7. A device for prioritizing disbursements for an electronic reverse mortgage application, comprising:
a hardware processor; and
a memory device storing instructions that, when executed by the hardware processor, perform operations, the operations comprising:
displaying via a graphical user interface, the disbursements of proceeds calculated by the electronic reverse mortgage application;
receiving user inputs to the graphical user interface that represent graphical movements within the graphical user interface of the disbursements of the proceeds determined by the electronic reverse mortgage application;
determining graphical positions of the disbursements of the proceeds displayed via the graphical user interface, the graphical positions based on the user inputs to the graphical user interface that represent the graphical movements;
assigning pre-set priorities to the disbursements of the proceeds, the pre-set priorities assigned based on the graphical positions of the disbursements of the proceeds displayed via the graphical user interface;
in response to the user inputs to the graphical user interface that represent the graphical movements of the disbursements of the proceeds, triggering a recalculation of the disbursements of the proceeds by the electronic reverse mortgage application;
identifying software calculators for recalculating the disbursements of the proceeds; and
generating prioritized disbursements as outputs to the electronic reverse mortgage application by sequentially executing the software calculators according to the pre-set priorities assigned based on the graphical positions.

8. The device of claim 7, wherein the operations further comprise calculating the disbursements of the proceeds.

9. The device of claim 7, wherein the operations further comprise receiving the user inputs via a communications network.

10. The device of claim 7, wherein the operations further comprise receiving the user inputs from a client device.

11. The device of claim 7, wherein the operations further comprise persistently storing the disbursements of the proceeds in a non-volatile memory.

12. The device of claim 7, wherein the operations further comprise persistently storing the pre-set priorities in a non-volatile memory.

13. A memory device storing instructions that when executed by a hardware processor perform operations, the operations comprising:
displaying via a graphical user interface, the disbursements of proceeds calculated by the electronic reverse mortgage application;
receiving user inputs to the graphical user interface that represent graphical movements within the graphical user interface of the disbursements of the proceeds determined by the electronic reverse mortgage application;
determining graphical positions of the disbursements of the proceeds displayed via the graphical user interface, the graphical positions based on the user inputs to the graphical user interface that represent the graphical movements;
assigning pre-set priorities to the disbursements of the proceeds, the pre-set priorities assigned based on the graphical positions of the disbursements of the proceeds displayed via the graphical user interface;
in response to the user inputs to the graphical user interface that represent the graphical movements of the disbursements of the proceeds, triggering a recalculation of the disbursements of the proceeds by the electronic reverse mortgage application;
identifying software calculators for recalculating the disbursements of the proceeds; and
generating prioritized disbursements as outputs to the electronic reverse mortgage application by sequentially executing the software calculators according to the pre-set priorities assigned based on the graphical positions.

14. The memory device of claim 13, wherein the operations further comprise calculating the disbursements of the proceeds.

15. The memory device of claim 13, wherein the operations further comprise receiving the user inputs via a communications network.

16. The memory device of claim 13, wherein the operations further comprise receiving the user inputs from a client device.

17. The memory device of claim 13, wherein the operations further comprise persistently storing the disbursements of the proceeds in a non-volatile memory.

18. The memory device of claim 13, wherein the operations further comprise persistently storing the pre-set priorities in a non-volatile memory.
